(19) United States
(12) Patent Application Publication
(10) Pub. No.: US 2019/0320678 A1
(43) Pub. Date: Oct. 24, 2019

(54) FREEZING FRUIT AND VEGETABLE JUICE

(71) Applicant: 10742694 Canada Inc., Toronto (CA)

(72) Inventors: Ravi Mohan, Toronto (CA); Helen Gaghadar, Toronto (CA)

(73) Assignee: 10742694 Canada Inc.

(21) Appl. No.: 15/961,689

(22) Filed: Apr. 24, 2018

(51) Int. Cl. A23G 9/04; F25C 1/04; A23L 2/42; A23L 3/36

(52) U.S. Cl. CPC A23G 9/045; F25C 1/04; A23G 2200/14; A23L 3/363; A23L 2/42

(57) ABSTRACT

A method of freezing juice includes dispensing a predefined amount of the juice into a container, contacting at least one surface of the container with a mass of cooling agent, having a temperature below −78° C., to cool the juice to a cooled juice temperature between −68° C. and −78° C. The container is configured to, in a first cooling stage, allow heat transfer from the juice to the cooling agent to reduce the temperature of the juice to 0° C. at a rate of between 1° C. and 2° C. per minute, and in a second cooling stage following the first cooling stage, allow heat transfer from the juice to the cooling agent to reduce the temperature of the juice to the cooled juice temperature, at a rate of between 1° C. and 2° C. per minute. The temperature of the juice is then maintained between −68° C. and −86° C.

### TECHNICAL FIELD

This relates to extracting juice from fruits and/or vegetables and cooling such juices into a frozen state.

### BACKGROUND

Juice may be formed from fruits and vegetables, and may include ingredients such as wheatgrass, ginger and turmeric (forming the base ingredients of a variety of juice product combinations). Common juice vegetable ingredients include carrot, kale, beet, celery, cucumber, lemon, parsley, chard, and spinach.

A conventional cold-press process may be used to produce juice. In a cold-press process, fruits and/or vegetables are first shredded or chopped into a pulp, for example, using a steel rotating grinder. The pulp may be collected in a filter bag. The pulp is then pressed, for example, with a hydraulic press. The pressure from the press causes the juice and water content to be extracted from the pulp, and drip, for example, into a collection tray, leaving behind the fibre content of the fruits and/or vegetables, which may be a source of dietary fibre.

By pressing fruits and vegetables using a cold-press process, less damage may be imparted to the nutrients than in a juicing process such as a centrifugal juicer. A centrifugal juicer, by contrast, may utilize a fast-spinning metal blade that spins against a mesh filter, separating juice from flesh by way of a centrifugal force and thereby generating friction and heat which may destroy enzymes and oxidize nutrients, rendering less nutritious juice than a cold-press juicer.

Cold-pressing juice may minimize heat and oxidation, and may be designed to maximize extraction of natural sugars, trace minerals, vitamins and enzymes from the fruits and vegetables.

Conventional juice preservation techniques may be used to increase the shelf life of a juice by killing or inactivating certain microorganisms, in particular, bacteria such as pathogens, and to inhibit their growth. Traditional preservation techniques include pasteurization. In a traditional example, pasteurization can involve heating a juice to at least 72° C. for at least 15 seconds, then cooling it to 4° C. to kill a large number of microorganisms, and in particular pathogens, in the juice.

Pasteurization is a thermal treatment to achieve reduction in pathogens. Other techniques to achieve a desired reduction in pathogens include non-thermal treatment. A desired reduction in pathogens may be defined, for example, as a 5-log₁₀ reduction of the most resistant pathogen of concern, where “5-log₁₀ reduction” means lowering the number of microorganisms by 100,000-fold. For example, if a surface has 100,000 pathogenic microbes on it, a 5-log reduction would reduce the number of microorganisms to one.

An example of non-thermal treatment is high pressure processing (“HPP”) (also referred to as “pascalization”). HPP is a “cold pasteurization” technique in which a juice is subjected to very high pressure, leading to the inactivation of certain microorganisms and enzymes.

Another example of a non-thermal treatment is exposing a juice to ultraviolet radiation to inactivate microorganisms.

In an effort to retain features of cold-pressed juice, such as maintaining texture and microscopic cellular structure, it may be desirable to avoid heat damage caused by methods such as pasteurization, and thus a non-thermal treatment may be used to achieve reduction in pathogens, or no treatment for reducing pathogens may be applied at all.

Best practices in the production of juice may recommend that unpasteurized juice be immediately refrigerated (between 0 to 4° C.) or frozen (to less than −18° C.) and should be held at those temperatures until ready to consume.

A juice may be frozen to extend its shelf life for storage and transport. Juice may be frozen using traditional freezing techniques such as blast freezing by blowing cold air over the juice. However, this freezing process may result in large ice crystals formed in the juice, which can alter the taste, texture, and nutritional value of the juice, as degradation of the juice occurs.

Accordingly, there is a need to maintain the cellular structural integrity, appearance and taste of the juice after cold-pressing. In particular, there is a need to freeze the juice in such a way that minimizes damage to the cellular integrity of the juice.

### SUMMARY

According to an aspect, there is provided a method of freezing a juice, the method comprising: dispensing a predefined amount of the juice into a container; contacting at least one surface of the container with juice with a mass of cooling agent, having a temperature below −78° C., to cool the juice to a cooled juice temperature between −68° C. and −78° C., wherein the container is configured to: in a first cooling stage, allow heat transfer from the juice to the cooling agent to reduce the temperature of the juice to 0° C. at a rate of between 1° C. and 2° C. per minute, and in a second cooling stage following the first cooling stage, allow heat transfer from the juice to the cooling agent to reduce the temperature of the juice to the cooled juice temperature, at a rate of between 1° C. and 2° C. per minute; and maintaining the temperature of the juice at between −68° C. and −86° C.

Other features will become apparent from the drawings in conjunction with the following description.

### BRIEF DESCRIPTION OF THE DRAWINGS

In the figures which illustrate example embodiments,

FIG. 1 is a schematic diagram of a juice production process, including a three-stage cooling process for freezing juice from fruits and/or vegetables and a dehydration process for preparing cold-pressed powders, according to an embodiment;

FIG. 2 is a graph illustrating a freezing preservation dynamics curve of a three-stage cooling process, according to an embodiment;

FIG. 3 is a graph illustrating the freezing preservation dynamics curve of FIG. 2, and a conventional cooling curve;

FIG. 4 illustrates the physical properties and shapes of the ice crystals formed in two samples of a final frozen juice using a three-stage cooling process, according to an embodiment, and two samples of a final frozen juice using a conventional cooling;

FIG. 5 illustrates a sample of ginger turmeric tea photographed at a time of zero minutes of cooling, and again at eight minutes of cooling with three-stage cooling process, according to an embodiment;

FIG. 6 illustrates the sample of FIG. 5, further cooled to a time of 14 minutes, according to an embodiment, and a sample of ginger turmeric tea frozen using a conventional cooling;

FIG. 7 illustrates sedimentation in a sample cooled using three-stage cooling process, according to an embodiment, and a sample cooled using a conventional cooling; and

FIG. 8 illustrates melting of a sample cooled using three-stage cooling process, according to an embodiment, and a sample cooled using a conventional cooling.

### DETAILED DESCRIPTION

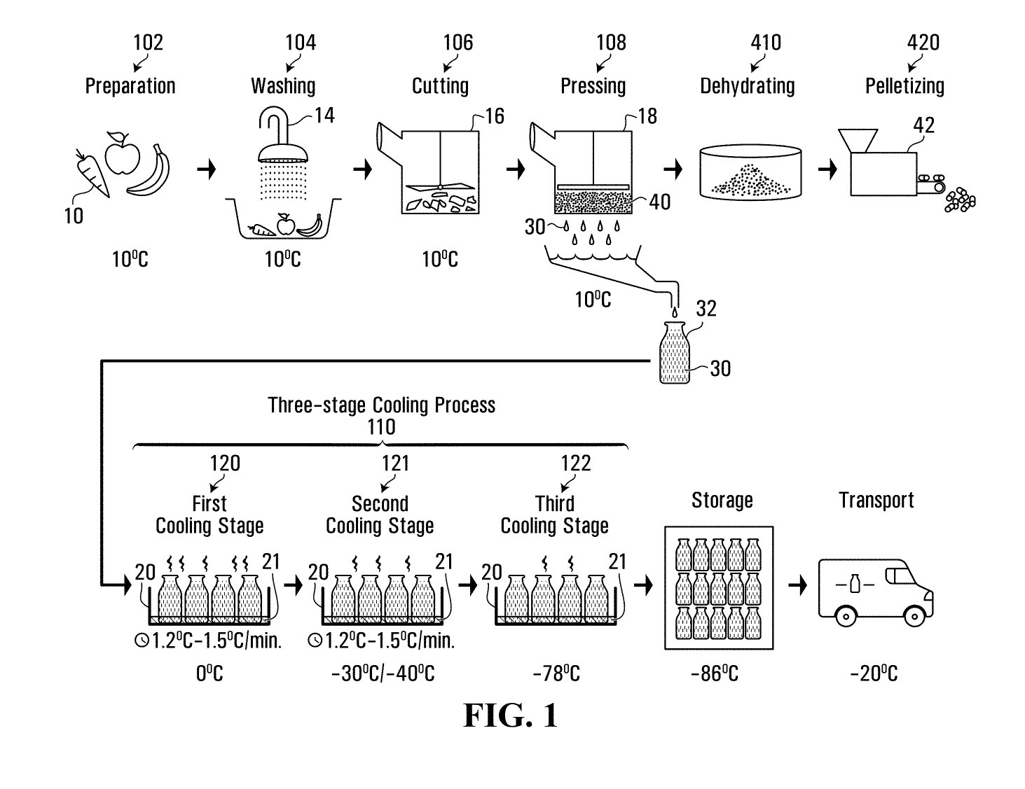

FIG. 1 is a schematic diagram of a juice production process 100. Juice production process 100 may be performed using equipment, described in further detail below, chilled to a set temperature for each stage of the process. In some embodiments, all of the equipment used in juice production process 100 is pre-chilled to a set temperature, forming a cold production line, in conditions, for example, below 10° C. Juice production process 100 illustrated in FIG. 1 may take place exclusively or primarily in a temperature-controlled climate, for example, in a walk-in cooler that is set to an ambient temperature of 10° C. The ambient temperature of juice production process 100 area may be accomplished using air conditioning or other cooling methods known to a person skilled in the art.

As illustrated in FIG. 1, juice production process 100 may include the steps of preparation 102, washing 104, chopping 106, pressing 108, a three-stage cooling process 110 having a first cooling stage 120, a second cooling stage 121, and a third cooling stage 122, following which storage and/or transport may occur.

FIG. 1 also illustrates a dehydration process for preparing cold-pressed powders following pressing 108, including steps of dehydrating 410 and pelletizing 420, which may also occur.

At preparation 102, ingredients 10 such as fruits and vegetables are prepared. For example, parts of ingredients 10 that are not usable for juice preparation or for discard are cut off, for example, leaves of a carrot. This may be manually performed by a worker, for example, with a knife at a cutting table.

The top surface of a cutting table used for preparation 102 may be formed, for example, from stainless steel or marble. The cutting table may be cooled. Cooling may be achieved, for example, by water cooling. In some embodiments, water is used as a heat conductor that flows through tubing that is adjacent the underside of the top surface of the cutting table. Using the principles of convection, heat is transferred from the top surface of the cutting table to the water. In other embodiments, the cutting table may be cooled using, for example, a system consisting of an evaporator, compressor and condenser, or by placing a cooled product, such as ice, adjacent the cutting table. Further cooling methods known to a person skilled in the art may be used to cool the cutting table.

In some embodiments, various components at preparation 102 may be chilled, used for fifteen minutes, and then replaced with a replacement chilled component.

At washing 104, ingredients 10 are then washed, for example, in a sink 14. Wash 104 may be performed at a temperature of approximately 10° C. All ingredients 10 may be handled and washed according to generally accepted food handling and safety principles, as would be understood by a person of ordinary skill in the art.

Once washed, at cutting 106, ingredients 10 are cut, chopped or ground by cutter 16 into smaller pieces suitable for use in a cold-press juicing machine.

After being cut to a suitable size, or for example, ground to a juice pulp, at pressing 108, juice 30 is extracted from ingredients 10 as ingredients 10 are pressed with cold-press 18. Cold-press 18 uses a press to extract juice from fruit and vegetables. In some embodiments, pressing may be performed by a hydraulic press which applies pressure to ingredients 10 to press out juice 30, with pulp 40 remaining, in a manner known to a person skilled in the art.

In some embodiments, chopping 106 and pressing 108 may be combined to be performed by a single piece of equipment. For example, in some embodiments, ingredients 10 may be fed into a shaft in which a spinning grinder cuts ingredients 10 into smaller pieces that are collected in a linen cloth filter bag. The filled filter bag is then transferred to a hydraulic press tray. The hydraulic press is activated to apply pressure to the filter bag to press out the juice from ingredients 10. Other equipment that integrates chopping 106 and pressing 108 may be used, as known to a person skilled in the art, and may include, for example, a Norwalk™ 280 cold pressed juicer or a Goodnature™ juicer such as model X1 or X6.

As shown in FIG. 1, resulting pulp 40 may continue to dehydrating 410 step, for pulp 40 to be dehydrated in dehydrator 41. In some embodiments, dehydrating 410 may be achieved by freeze drying, by rapidly freezing pulp 40 and subjecting it to a vacuum that removes ice from the frozen pulp 40 by sublimation.

After being dehydrated, pulp 40 may continue to pelletizing 420, and a pelletizing machine such as a pellet mill or pellet press may form the dehydrated pulp 40 into pellet form for storage and transport. In some embodiments, dehydrated pulp 40, either as a pellet or loose, may be vacuum sealed into packaging.

In some embodiments, juice 30 may be combined with other liquids or beverages, for example, tea.

A predefined amount of resulting juice 30 from pressing 108 is dispensed into a container 32. In the example shown in FIG. 1, container 32 may be a glass bottle. In some embodiments, container 32 may be a container made of a suitable food-grade material, for example, a plant-based material, that is capable of withstanding temperatures obtained during three-stage cooling process 110, which is described in further detail below.

In some embodiments, container 32 may be a mold formed from a plant-based material, similar to an ice cube tray, having separate and independent mold sections of, for example, 30 cubic centimetres in size, each mold section containing a portion of juice 30.

In some embodiments, juice 30 may be vacuum-sealed in container 32, for example, in packaging composed of polyamide (“PA”) and polyethylene (“PE”). In some embodiments, other plastic materials such as polyvinylidene chloride (“PVDC”) or ethylene vinyl alcohol (“EVOH”) may be used.

The parameters of container 32 are defined and the container is selected based on properties required to achieve three-stage cooling process 110, described in more detail below.

Returning to FIG. 1, following dispensing of a predefined amount of juice 30 into container 32, cooling and freezing of juice 30 in container 32 is then performed in three-stage cooling process 110, which may arrest the growth and reproduction of microorganisms such as bacteria, in particular, pathogens.

Under traditional conditions of cooling and freezing a juice, large ice crystals may form which may damage cell membranes present in the juice, and may result in altered taste, texture and nutritional values, and degradation of the juice.

The process of stabilizing biological materials at cryogenic temperatures (for example, at temperatures below −50° C.), known as cryopreservation, may have advantages over traditional freezing techniques.

Controlled freezing to cryogenic temperatures may result in a greater number of sites of nucleation, namely, the points where ice crystal forms. As a result, there may be smaller crystal formation and less damage to cellular membrane integrity of the biological materials. As a result, food texture and taste may be maintained following cryopreservation. In addition, cryopreservation may inhibit the growth of microorganisms and slow down chemical changes that may affect or cause food spoilage.

The quality of frozen products may be dependent on the rate of freezing of the product. Slow cooling may lead to freezing occurring external to a cell before intracellular ice begins to form. As this happens, there is less water outside the cell. The osmotic balance shifts, resulting in intracellular water leaving the cell and degradation of the cell. By contrast, fast cooling may minimize water leaving the cell, as more intracellular ice is formed, thereby minimizing the osmotic imbalance. Taken together, a cooling rate of between 1° C. and 2° C. per minute, and preferably at 1° C. per minute, may optimize ice crystal formation for a volume of juice.

Three-step cooling process 110 will now be explained in more detail. In some embodiments, each of first cooling stage 120, second cooling stage 121, and third cooling stage 122 may correspond to stages for pre-freezing, freezing and storage, respectively, for example, in accordance with international refrigeration standards.

In first cooling stage 120 of three-stage cooling process 110, the temperature of juice 30 is reduced at a controlled rate of between 1° C. and 2° C. per minute (namely, the temperature is reducing by between −1° C. and −2° C. per minute), for example, reducing between 1.2° C. and 1.5° C. per minute, until a first ice crystal forms at approximately 0° C. This may occur, for example, at 6 to 9 minutes, by applying dry ice in contact with at least one surface container 32 containing juice 30, as discussed in further detail below.

During first cooling stage 120, the intent is to form multiple nucleation sites to minimize the size of formed ice crystals.

Following completion of first cooling stage 120 of three-stage cooling process 110, juice 30 is further cooled in second cooling stage 121 to a cooled juice temperature, for example, between −68° C. and −78° C. at a continued controlled rate of between 1.2° C. and 1.5° C. per minute.

During second cooling stage 121, juice 30 reaches a fully-frozen solid state. This may occur, for example, at 14 minutes, by applying dry ice in contact with at least one surface of container 32 containing juice 30, as discussed in further detail below

In some embodiments, for example, as illustrated in FIG. 1, cooling during first cooling stage 120 and second cooling stage 121 may be achieved by placing at least one surface of container 32 containing juice 30 in contact with a mass of cooling agent 21. Cooling agent 21 may have a temperature of below of −78° C.

In some embodiments, cooling agent 21 may be, for example, dry ice (solid carbon dioxide) in vessel 20. The dry ice may be, for example, in 1 to 2 inch thick blocks or in pellet form and at a surface temperature, for example, of −78.5° C.

Cooling agent 21 is illustrated in FIG. 1, in an embodiment, as pellets of dry ice.

Cooling during first cooling stage 120 and second cooling stage 121 may be performed in vessel 20 by a tray that can be lowered or raised to adjust or control the contact of the surfaces of container 32 containing juice 30 with cooling agent 21. A thermometer in a sample of juice 30 may be used to sense temperature and the rate of cooling.

In some embodiments, container 32 may be configured to allow heat transfer of juice 30 to cooling agent 21 to reduce the temperature of juice 30 to 0° C. at a rate of between 1° C. and 2° C. per minute, in first cooling stage 120, and allow heat transfer of juice 30 to cooling agent 21 to reduce the temperature of juice 30 to a cooled juice temperature of between −68° C. and −78° C. at a rate of between 1° C. and 2° C. per minute, in second cooling stage 121.

Parameters of container 32 configured to achieve first cooling stage 120 and second cooling stage 121 may include, for example, the surface area of container 32, the surface area of container 32 that is in contact with cooling agent 21, the surface-area-to-volume ratio (surface area per unit volume) of container 32 and juice 30, the thickness of container 32, the material of container 32 and its thermal conductivity, and the overall heat transfer coefficient between cooling agent 21, container 32 and juice 30.

In an example, the higher the surface-area-to-volume ratio of container 32 and juice 30, the faster container 32 and juice 30 may respond to changes in temperature.

In some embodiments, the parameters of cooling agent 21 and juice 30 may also be selected to achieve the desired cooling rate (for example, between 1.2° C. and 1.5° C. per minute) of cooling during first cooling stage 120 between room temperature (for example, 10° C.) and freezing (0° C.) when the first ice crystal forms in juice 30, and in second cooling stage 121.

Parameters of cooling agent 21 and juice 30 that may be selected to dictate cooling rate may include, for example, the size and volume of cooling agent 21, the volume of juice 30 in container 32, the surface-area-to-volume ratio (surface area per unit volume) of container 32 and juice 30, and the contents of juice 30 and its thermal conductivity,

Following completion of first cooling stage 120 and second cooling stage 121 of three-stage cooling process 110, juice 30 is further cooled or maintained at a cooling point temperature, for example, between −68° C. and −86° C., in an example −86° C. in third cooling stage 122, at which frozen juice 30 is to be initially stored.

During third cooling stage 122, juice 30 may be cooled by placing container 32 containing juice 30 in a freezer with an ambient temperature of −86° C. Container 32 containing juice 30 may remain in such a freezer until juice 30 reaches −86° C., for example, after six hours.

In some embodiments, third cooling stage 122 may be achieved by submerging container 32 containing juice 30 into a vessel containing a cryogenic liquid, for example, liquid nitrogen.

By freezing juice 30 in a manner that controls the rate of cooling using the controlled three-stage cooling process 110 having first cooling stage 120, second cooling stage 121, and third cooling stage 122, in comparison with conventional methods such as blast freezing, smaller ice crystals may be produced, which may result in less damage to cell structures. Frozen cubes of juice 30 may be stored at −86° C.

Maintaining juice 30 at a temperature below −35° C. during third cooling stage 122 for 15 hours or more may destroy pathogens, such as parasites or parasite eggs, present in juice 30.

The example in Graph 1 is provided to exemplify particular features. A person of ordinary skill in the art will appreciate that the scope of the present is not limited to the particular features exemplified by this example.

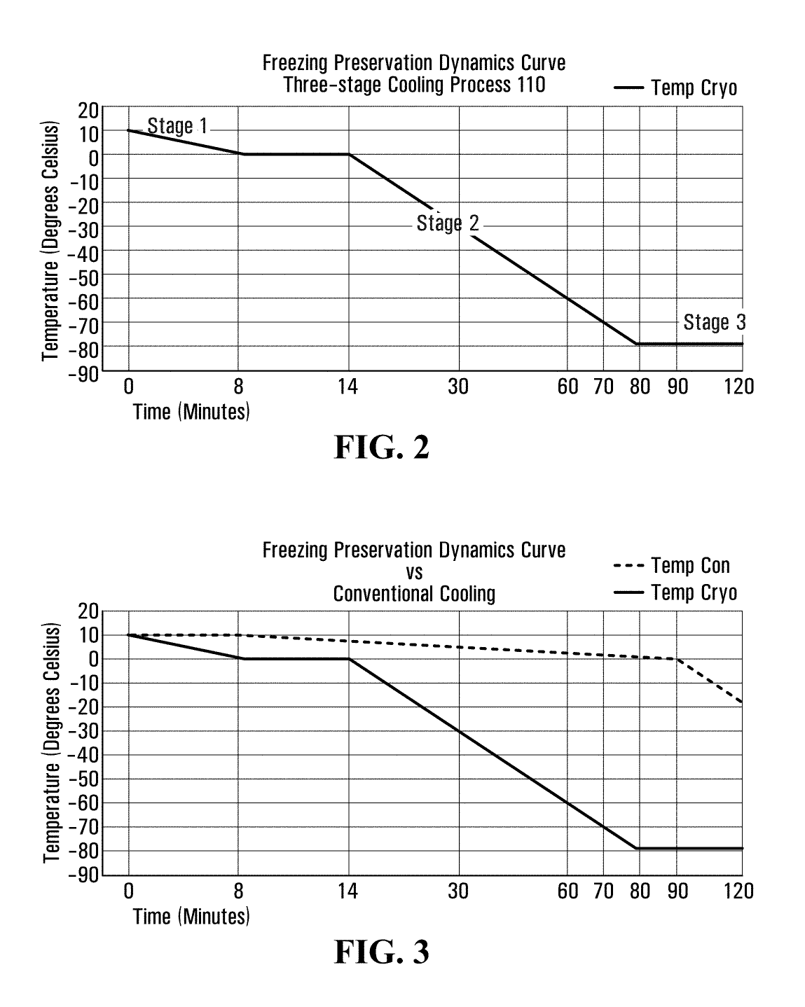

FIG. 2 illustrates Graph 1, with a cooling curve labelled “TEMP CRYO”, according to an embodiment of three-stage cooling process 110 for juice 30.

In Graph 1, the x-axis represents time in minutes, and the y-axis represents temperature in degrees Celsius. Graph 1 illustrates first cooling stage 120 (labelled as “Stage 1”) at a cooling rate of approximately 1.2° C. per minute until approximately freezing point (0° C.) is reached. During second cooling stage 121 (labelled as “Stage 2”), juice 30 continues to be cooled to a cooled juice temperature of −78° C., following which in third cooling stage 122 (labelled as “Stage 3”) juice 30 is maintained at a temperature of approximately −78° C.

In another embodiment, in experimental work to date, there is evidence that cryopreservation of plant cells, for example, those from a fruit or vegetable in a juice, may be accomplished by a process in which a three-step cooling process is used and cells are held at −30° C. for a period of time before third cooling stage cooling to liquid nitrogen temperatures, for example, −78° C. This process may enhance the dehydration of the cells prior to freezing. Similarly, it may promote early nucleation sites leading to smaller ice crystals and less mechanical damage to cell walls.

FIG. 3 illustrates Graph 2, the cooling curve of three-stage cooling process 110, labelled “TEMP CRYO” as in Graph 1 of FIG. 2, overlayed with a conventional cooling, for example in a conventional freezer set to −18° C., labelled “TEMP Con”, at a rate of 0.4° C. per minute until a temperature of approximately 0° C. is reached, following cooling to −18° C. The x-axis represents time in minutes, and the y-axis represents temperature in degrees Celsius.

During testing, conventional cooling at a rate of 0.4° C. per minute until a temperature of 0° C. is reached resulted in observations of a slight loss of flavour, poor crystal formation and a slower freeze. By contrast, a “controlled” cooling rate of 1.2° C. to 1.5° C. per minute until freezing, according to an embodiment of three-stage cooling process 110, resulted in observations of a better taste, better (smaller) crystal formation, and faster freeze.

The three-stage cooling process 110 resulted in a frozen juice having smaller ice crystals, a higher density (namely, a more homogenous mixture with less sedimentation), and longer melting times.

A higher density of ice crystals may be achieved using three-stage cooling process 110 as a result of the unidirectional freeze imparted by cooling agent 21, in contrast to a traditional freezer that freezes from all sides, trapping air and other impurities. Higher density of ice crystals may result in a slower melt.

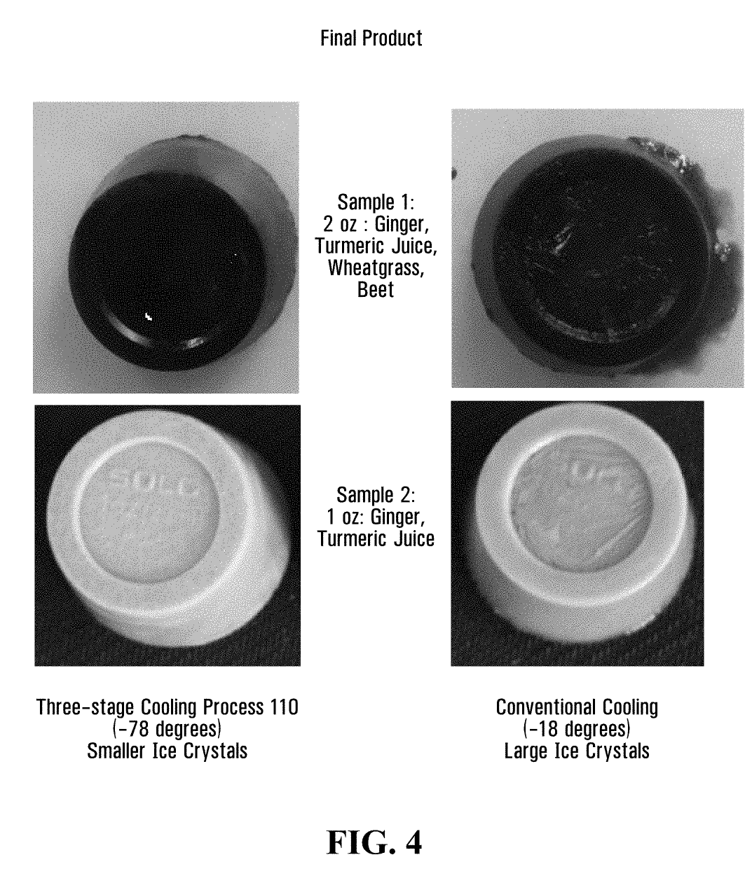

FIG. 4 illustrates two samples of the physical properties and shapes of the ice crystals in frozen juice 30 using three-stage cooling process 110 to reach −78° C., in comparison with the physical properties and shapes of the ice crystals in juice frozen using a conventional cooling at a rate of 0.4° C. per minute to reach −18° C. Sample 1 is a two ounce juice produce containing ginger, turmeric juice, wheatgrass and beet ingredients. Sample 2 is a one ounce juice product containing ginger and turmeric juice.

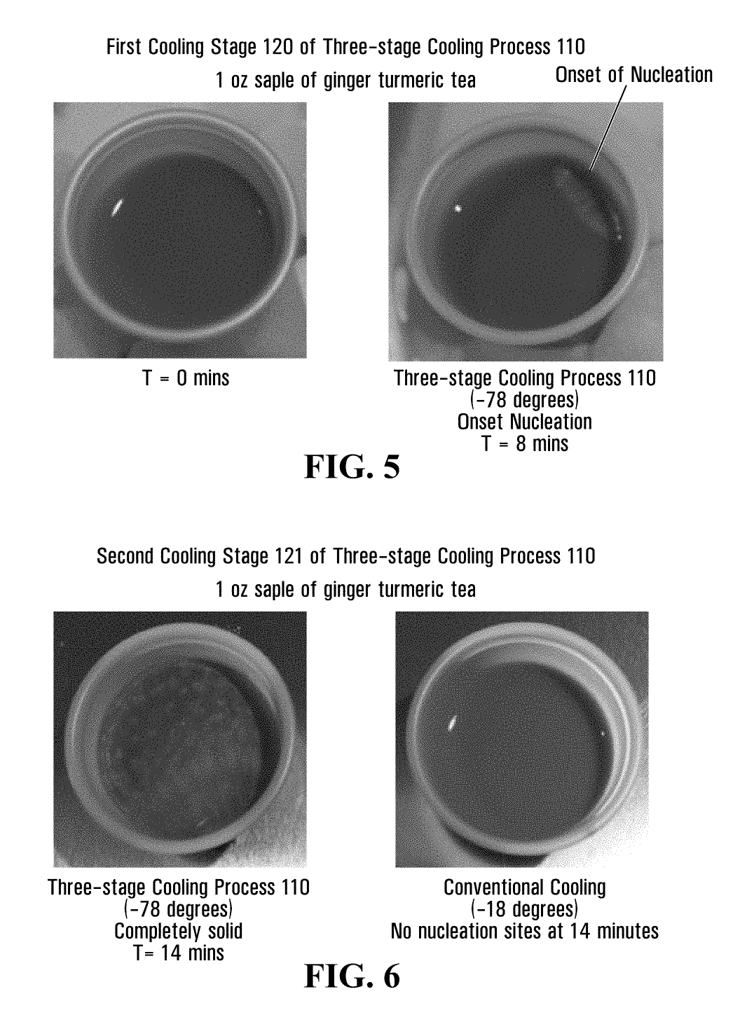

FIG. 5 shows a one ounce sample of ginger turmeric tea, photographed at a time of zero minutes of cooling, and again at eight minutes of cooling with three-stage cooling process 110. As shown in FIG. 5, a typical early nucleation site appeared at eight minutes using three-stage cooling process 110 in an embodiment.

FIG. 6 illustrates the samples of FIG. 5, further cooled at a time of 14 minutes. The three-stage cooling process 110 sample is at this stage being cooled in second cooling stage 121. As shown in FIG. 6, at 14 minutes the sample using three-stage cooling process 110 is fully frozen.

The rate of freezing may also impact the rate at which macroscopic particulate matter (for example, turmeric and ginger particulates) sediment in a juice. Under normal freezing, which may take up to 90 minutes to reach 0° C., there is significantly more particulate sedimentation compared to the faster freezing rates using three-stage cooling process 110.

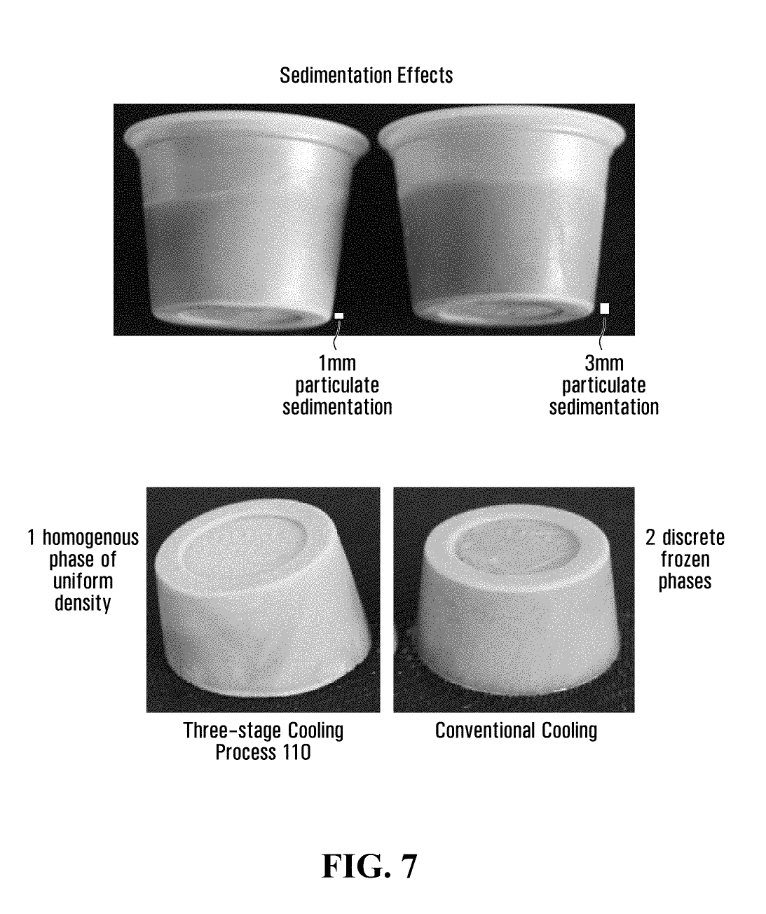

As illustrated in FIG. 7, three-stage cooling process 110 may result in a more homogenous density of particulate matter in frozen juice. FIG. 7 illustrates a one ounce sample of ginger turmeric tea cooled to −78° C. using three-stage cooling process 110 and a one ounce sample of ginger turmeric tea cooled using a conventional cooling at a rate of 0.4° C. per minute to reach −18° C.

FIG. 7 shows that the amount of sedimentation is markedly (more than 50%) reduced using three-stage cooling process 110. As shown, a sample formed using three-stage cooling process 110 may result in less than 1 mm of particulate sedimentation at the bottom of the frozen juice, and one homogenous phase of uniform density. A sample formed using conventional cooling may result in 3 mm of particular sedimentation, and separates into two discrete frozen phases of the juice.

Accordingly, using three-stage cooling process 110 may result in a more equal per unit volume distribution of turmeric (extracted from the root liquids of different densities) within a given sample.

With less sedimentation, there may be less residue in container 32 when juice 30 is removed from container 32, ultimately resulting in a higher concentration of product being consumed and less nutrient rich sediment left in the bottom of container 32.

Returning to FIG. 1, once juice 30 has been frozen using three-stage cooling process 110, frozen juice 30 may be prepared for storage and transportation.

In some embodiments, frozen juice 30, for example, in collections of 30 cubic centimetre cubes, if not already vacuum-sealed, may be vacuum-sealed within packaging by removing air from the package prior to sealing.

Frozen juice 30 may be initially stored at a temperature of −86° C.

Frozen juice 30 may be transported to an end-consumer or retailer at −78° C., for example, by being transported to retailers while in contact with dry ice.

Frozen juice 30 may be stored, for example, at −20° C. in a retailer's freezer, for a consumer to purchase in-store.

Upon purchase, frozen juice 30 may be then stored in a consumer's freezer, for example at −17° C. or lower.

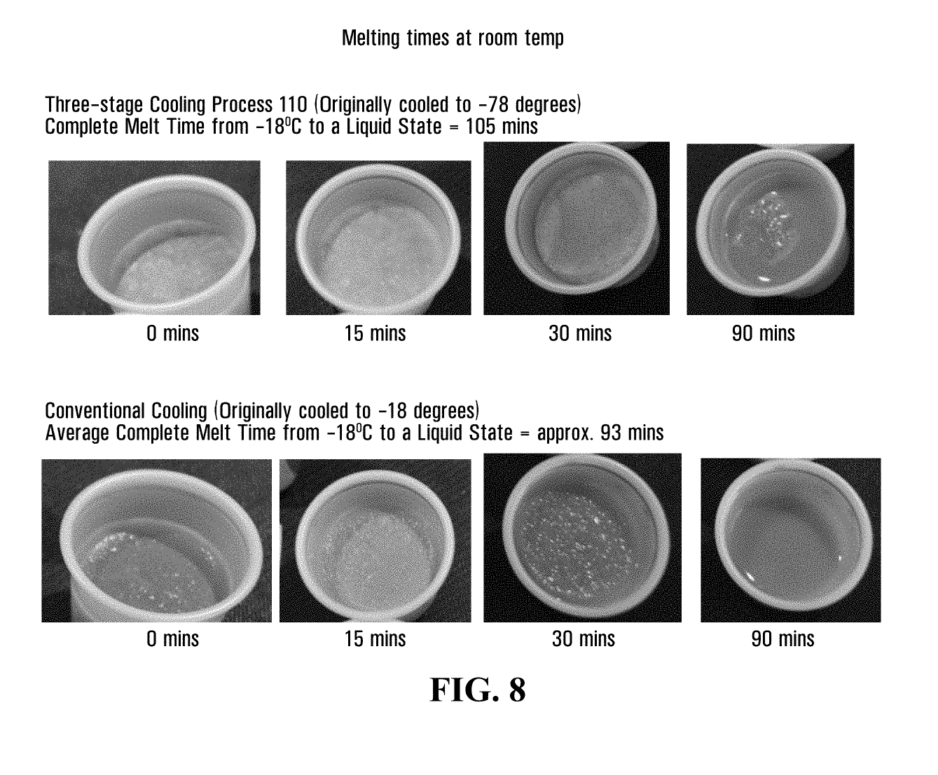

FIG. 8 illustrates a one ounce ginger turmeric tea sample prepared using three-stage cooling process 110 to a temperature of −78° C., as well a one ounce ginger turmeric tea sample prepared using conventional cooling techniques to a temperature of −18° C. After reaching these temperatures, both samples were placed in a −18° C. freezer to replicate conditions in an example retailer environment.

The average melting time from solid frozen juice at −18° C. to complete liquid was 93.3 minutes for the sample prepared using convention cooling techniques, compared to a melting time of 104.9 minutes to melt the solid frozen juice 30 formed using three-stage cooling process 110 to complete liquid.

As illustrated in FIG. 8, frozen juice 30, prepared using three-stage cooling process 110 to a temperature of, for example, −78° C., may, in a room temperature environment, remain frozen for a longer period of time than a juice frozen using convention cooling techniques to −18° C. This may allow for greater flexibility in transporting frozen juice between a retailer and a consumer in a final location.

In use, a frozen juice 30 formed using three-stage cooling process 110 may be stored in a consumer's freezer, and once thawed may be kept refrigerated and consumed within six to twelve hours.

As compared to conventional cooling techniques, three-stage cooling process 110 may result in faster nucleation and more nucleation sites, resulting in smaller ice crystals and less damage to cells in the juice. Three-stage cooling process 110 may also result in a frozen juice with less sedimentation and a more uniform density, resulting in less material at risk of being left in the container and a higher concentration of particulate per unit of frozen juice.

Freezing juice 30 using three-stage cooling process 110 may also, in some embodiments, preserve more of the nutritional integrity of the juice as compared to using conventional cooling techniques.

Juice production process 100 provides for a cold production chain from ingredient preparation to retail delivery. A longer melt time of a frozen juice formed using three-stage cooling process 110, as compared to conventional cooling techniques, may result in a product having better transportation characteristics (for example, transport form a retailer to a consumer's home).

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A method of freezing a juice, the method comprising:
dispensing a predefined amount of the juice into a container;
contacting at least one surface of the container with juice with a mass of cooling agent, having a temperature below −78° C., to cool the juice to a cooled juice temperature between −68° C. and −78° C.,
wherein the container is configured to:
in a first cooling stage, allow heat transfer from the juice to the cooling agent to reduce the temperature of the juice to 0° C. at a rate of between 1° C. and 2° C. per minute, and
in a second cooling stage following the first cooling stage, allow heat transfer from the juice to the cooling agent to reduce the temperature of the juice to the cooled juice temperature, at a rate of between 1° C. and 2° C. per minute; and
maintaining the temperature of the juice at between −68° C. and −86° C.

2. The method of claim 1, wherein the first cooling stage comprises reducing the temperature of the juice at a rate of between 1.2° C. and 1.5° C. per minute.

3. The method of claim 1, wherein the second cooling stage comprises reducing the temperature of the juice at a rate of between 1.2° C. and 1.5° C. per minute.

4. The method of claim 1, further comprising, following the second cooling stage, reducing the temperature of the juice at a rate of greater than 10° C. per minute.

5. The method of claim 1, wherein the cooled juice temperature is −78° C.

6. The method of claim 1, wherein the cooling agent is solid carbon dioxide.
